(19) United States
(12) Patent Application Publication
(10) Pub. No.: US 2007/0143929 A1
(43) Pub. Date: Jun. 28, 2007

(54) Combination Capo-Container Opener Device

(76) Inventor: Steven J. Selin, Ithaca, NY (US)

Correspondence Address: William Greener, Suite 201, 10 Brown Road, Ithaca, NY, 14850, US

(21) Appl. No.: 11/565,712

(22) Filed: Dec. 1, 2006

Related U.S. Application Data
(60) Provisional application No. 60/753,338, filed on Dec. 22, 2005.

(51) Int. Cl. B25F 1/00; B67B 7/00

(52) U.S. Cl. 7/151

(57) ABSTRACT

An embodiment of the invention is directed to a combination device that includes a capo for a stringed musical instrument such as a guitar or a banjo, and a beverage bottle and/or can opener integrally coupled to the capo. In various aspects of the embodiment, the container opener is an integral part of either a finger board-engaging portion, a neck-engaging portion or a tensioning member of the capo. In an alternative aspect, the container opener portion of the capo is a container surface-puncturing element, also commonly known as a church key.

### BACKGROUND OF THE INVENTION

Field of the Invention

Embodiments of the invention are generally directed to the interrelated fields of musical instrument accessories and leisure and, more particularly, to a combination utility device that is a capo for a musical stringed instrument and a bottle and/or can opener.

2. Description of Related Art

A capo, as it is commonly known, is a stringed musical instrument accessory that is used to shorten the effective length of the strings of the instrument and to thus change the pitch of the strings without the need to retune the instrument. The concept of the capo has been known for hundreds of years and well over 100 U.S. utility patents have issued for various types of capos.

FIGS. 1-5 show a variety of popular, commercially available capos. In general terms, the majority of capo designs commonly include a finger board engaging portion that presses the strings of the instrument against the finger board, a neck engaging portion that contacts the backside of the neck opposite the finger board engaging portion, and a tensioning member for biasing, clamping or otherwise providing the requisite compression between the finger board engaging portion and the neck engaging portion to properly operate as a capo.

The playing of musical instruments often occurs in a setting where the musician may want to consume a liquid refreshments. Liquid refreshments such as pop, soda, beer and others frequently come in bottles that are secured by a bottle cap. The traditional cap was originally referred to as a crown cork or crown cap. The crown cap was named as such after a fanciful view of the ring of crinkled points around the edge of the metal closure before it was clamped on the neck of the bottle. A special cap opening tool, long referred to as a church key, and more commonly referred to simply as a bottle opener, is used to pry the crimped bottle cap off of the bottle. Bottle openers come in countless varieties. For example, an opening end extending from a handle portion includes a closed loop of material of a given shape for contacting the cap and a tab projecting into the open area of the loop that engages the crimped cap edge. Alternatively, the opener has a tab or projection that can engage the crimped edge of the bottle cap to apply an upward force and a free arm or other surface that provides a stabilizing, leveraging force to the surface of the cap as the crimping is distorted when the opener is rotated vertically upwards. Other common variations also exist.

It is often the case that a musician playing a stringed instrument will have a bottle containing a liquid refreshment which, of course, can only be consumed during the short periods of time between the playing of music. If the refreshment is in a bottle with a crown cap or the like, or in a can that needs to be punctured, the musician will need to acquire a church key or other opening tool to open the bottle or the can. The absence of such a tool, or the inconvenience of trying to obtain such a tool in the short musical interludes may prevent the musician from consuming the beverage at all. Accordingly, the inventor has recognized a need for a bottle or can opening device that is readily available to the musician and which advantageously is combined with a common musical accessory likely to be within immediate reach of the musician.

### SUMMARY OF THE INVENTION

An embodiment of the invention is directed to a combination device that includes a capo for a stringed musical instrument such as a guitar or a banjo, and a bottle and/or can (hereinafter “container”) opener integrally coupled to the capo. The term integrally coupled means that the container opener is formed as an integral part of the capo in an end portion or a body portion thereof. As used herein, the term capo refers to any of a variety of well known devices that is used most typically on a guitar, a banjo, or other stringed musical instrument having an elongated neck portion and a finger board attached to the neck portion, for shortening the string length and thus facilitating upward transposition or higher pitch without altered fingering. In general terms, the capo includes a finger board-engaging portion that presses the strings of the instrument against the finger board when the capo is engaged, an instrument neck-engaging portion that is moveably connected to the finger board-engaging portion or a supporting structure thereof, which contacts the backside of the neck of the instrument opposite the finger board-engaging portion, and a tensioning member that is connected to either the finger board-engaging portion or the neck-engaging portion or a common frame member thereof. Depending upon the design of the capo, the tensioning member may include a biasing element such as a spring or a spring clip, a lever arm that includes a mechanically adjustable stop mechanism, a worm screw component, a ratchet component, and others, which are found in popular commercially available capos. The tensioning mechanism along with the engagement portion of the finger board-engaging portion and the neck-engaging portions do not constitute parts of the invention per se. In various aspects of the embodiment, the container opener is an integral part of either the finger board-engaging portion, the neck-engaging portion or the tensioning member. It is to be understood that reference herein to either the finger board-engaging portion, the neck-engaging portion or the tensioning member of the capo refers to the entire structure associated with that particular component and not just to a specific region such as, for example, the operative finger board contact surface of the finger board-engaging portion, and so on. According to an aspect, the container opener is coupled to a free end of one of the finger board-engaging portion, the neck-engaging portion and the tensioning member. In another aspect, the container opener is an integral part of a body portion of either the finger board-engaging portion, the neck-engaging portion or the tensioning member of the capo. According to another aspect, the container opener is a bottle cap remover As used herein, the term bottle cap will be used to refer at least to a crown cap type of cap having a crimped edge. However, it is to be understood that the device embodiment of the invention may be utilized to remove different types of caps from bottles where the bottle is opened by prying the cap off of the bottle. The container opener according to the aspect includes a bottle cap lip-engaging member and an integral stabilizing leverage member. In various aspects, the leverage member can be an independent projection of the container opener or a particular surface region of a portion of the container opener. The lip-engaging member and the leverage member will be separated by a distance sufficient, in operation of the opening function, to simultaneously engage a lip of the bottle cap and an exterior surface of the bottle cap, respectively, to facilitate the prying off of the cap from the bottle. The lip-engaging member will advantageously be narrower than the leverage member to facilitate its engagement with the undulating crimped region of a standard-sized crown cap. In an exemplary aspect, the lip-engaging member of the container opener will have a width (i.e. transverse dimension) of less than about 2 millimeters. In an alternative aspect, the container opener of the capo is a container surface-puncturing element, also commonly known as a church key. The surface puncturing element will include a container lip-engaging member for engaging a lip or edge of the container to be opened and an integral container puncturing member. In an illustrative aspect, the puncturing member has a tapered end to facilitate puncturing of the container surface.

These and other aspects of the embodiment of the invention, along with the various benefits and advantages provided by the embodiment of the invention, will be described in more detail below and as shown in the attached drawings and as set forth in the appended claims.

### BRIEF DESCRIPTION OF THE DRAWINGS

FIGS. 1-5 are photo copies of five popular commercially available capos;

FIG. 6 is a schematic diagram of a combination device according to an exemplary embodiment of the invention;

FIG. 7 is a schematic diagram of an exemplary combination device according to another embodiment of the invention;

FIG. 8 is a schematic diagram of an exemplary combination device according to another embodiment of the invention;

FIG. 9 is a schematic diagram of an exemplary combination device according to another embodiment of the invention;

FIG. 10 is a schematic diagram showing a more detailed aspect of an exemplary container opener portion of a combination device according to an embodiment of the invention; and

FIGS. 11A, 11B are respective plan and profile views of an exemplary container opener portion of a combination device according to another embodiment of the invention.

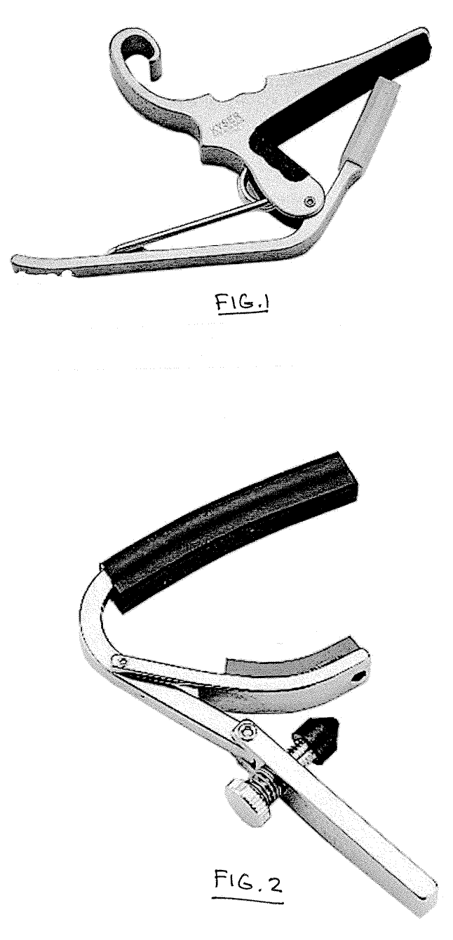

### DETAILED DESCRIPTION

An embodiment of the invention is directed to a combination device including a capo that can be used with a stringed musical instrument and a container opener that is an integral component of the capo. FIGS. 6-9 illustrate exemplary aspects of the embodiment in which the container opener is a crown cap type of opener.

As illustrated in FIG. 6, a combination capo-container opener device 100-1 is modeled after a Kyser® brand capo as shown in FIG. 6. The device includes a finger board-engaging portion 110 of the capo aspect of the device that will engage the strings and finger board of the musical instrument, a neck-engaging portion 120 of the capo aspect of the device that will engage the backside of the neck of the musical instrument, and a tensioning member 130 that functions to facilitate secure attachment and removal of the capo from the instrument. As shown in FIG. 6, the neck-engaging portion 120 is moveably coupled to the finger board-engaging portion 110 by a pivot mechanism 140. The tensioning member 130, according to the exemplary aspect is a wound, self-biasing spring member 133. The finger board-engaging portion 110 of exemplary device 100 has an oppositely extending region 113 in a curved shape as shown. The neck-engaging portion 120 similarly has an oppositely extending portion 123, a portion 125 of which engages part of the spring member 133. To engage/disengage the capo from the instrument, the oppositely extending portions 113, 123 are squeezed together in the direction of arrows 140 thus separating the respective jaw portions 112, 122 of the capo. Typically, the back surface 127 of the extending region 123 of neck-engaging portion 120 is flattened or contoured to engage the palm region of the musician's hand. The front surface 115 of the extending portion 113 of the finger board-engaging portion 110 is curved to fit one or more fingers of the musician's same hand.

As further shown in FIG. 6, the device 100-1 includes a container-opener component 150-1 formed as an integral part of the device. The opener 150-1 is shown in solid lines integrally coupled to and extending from the free end region 155 of the extending portion 113 of the finger board-engaging portion 110 of the device. The opener 150-1 has a bottle cap lip-engaging portion 162-1 and a cap leveraging portion 165-1. In the exemplary device 100-1, the cap leveraging portion 165-1 is merely an inner surface region 166 of the opener portion 150-1. The distance d between the leveraging portion 165-1 and a tip 164 of the cap lip-engaging portion 162-1 is sufficient to allow the tip 164 to hook the cap lip while the leveraging surface 166 contacts a diametrically opposed surface region of the cap as the opener is rotated in the direction of arrow 175.

In an alternative aspect the container opener 150-2 may be located at the free end 181 of the extending portion 123 of the neck-engaging portion 120 of the device, as shown in dotted lines in FIG. 6. As illustrated, the opener 150-2 has a cap lip-engaging member 162-2 and a cap surface-engaging leverage member 165-2. Upon engagement with a crown cap, the opener 150-2 is rotated in the direction of arrow 185 to remove the bottle cap.

FIG. 7 shows an alternative exemplary aspect of a combination device 100-2. The device 100-2 is modeled after a Shubb® brand capo as shown in FIG. 2 modified so that an illustrative opener 150-3 integrally extends from an extending end 240 of a tensioning member 250 of the device. The capo portion of the device 100-2 also includes a finger board-engaging portion 110-2 and a neck-engaging portion 120-2. A control mechanism 230 is used to facilitate engagement/disengagement of the capo from the instrument. In the device 100-2, the opener 150-3 is in the form of a closed loop 260 of material that acts as a leverage member 165-3. A cap lip-engaging member 162-3 projects as a peninsula into the open area 262 of the loop.

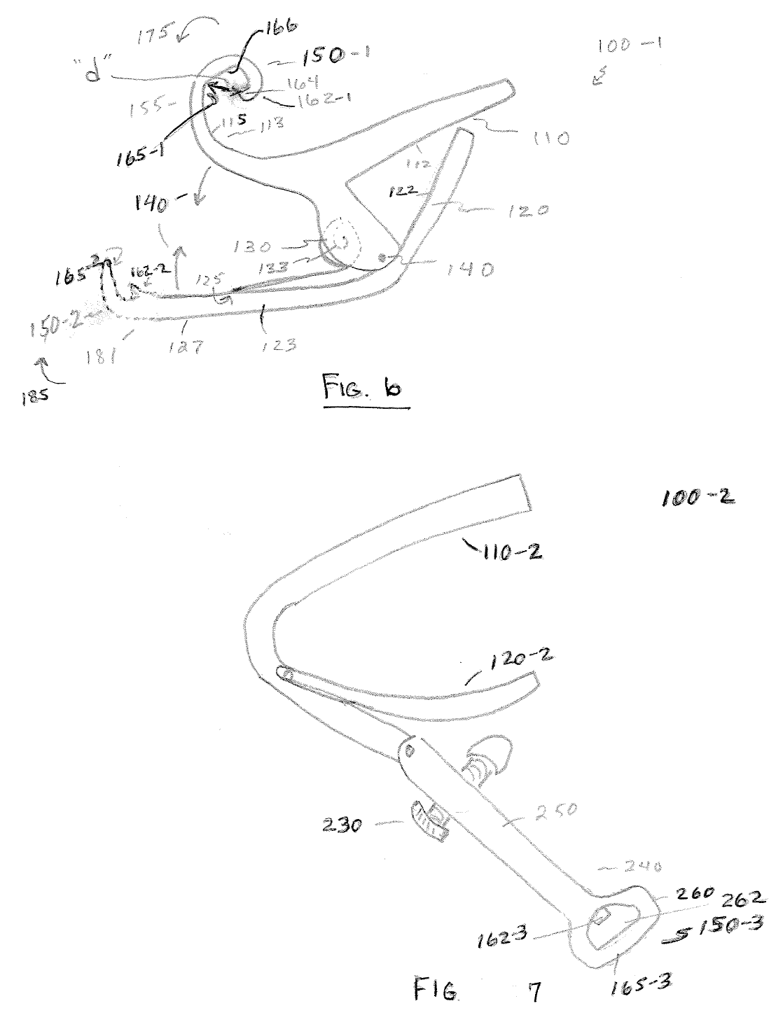

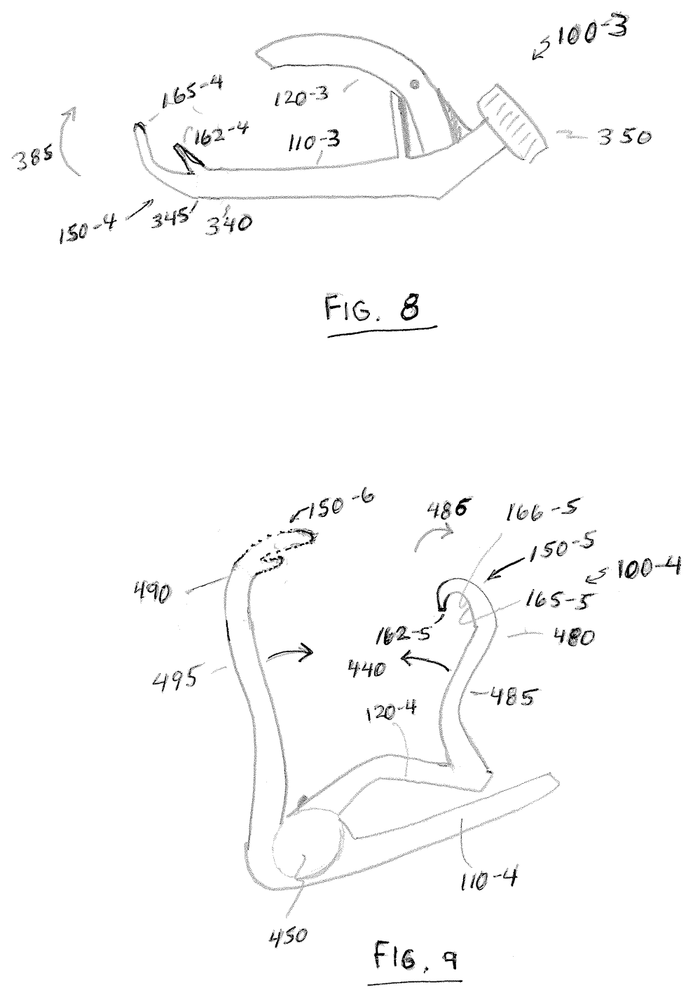

FIG. 8 illustrates a device 100-3 according to an embodiment of the invention in which the capo portion is modeled after a Dunlop® brand guitar capo as shown in FIG. 5. The device 100-3 includes a finger board-engaging portion 110-3, a neck-engaging portion 120-3 moveably connected thereto and a tensioning member 350. In this exemplary aspect, an opener 150-4 extends fro the end 345 of an extending portion 340 of the finger board-engaging portion 110-3. The opener 150-4 has a cap lip-engaging member 162-4 and a cap surface leverage member 165-4, similar to that of opener 150-2 shown in FIG. 6. When the opener 150-4 is engaged with a crown cap and rotated in the direction of arrow 385, the cap will be removed from the bottle it is attached to.

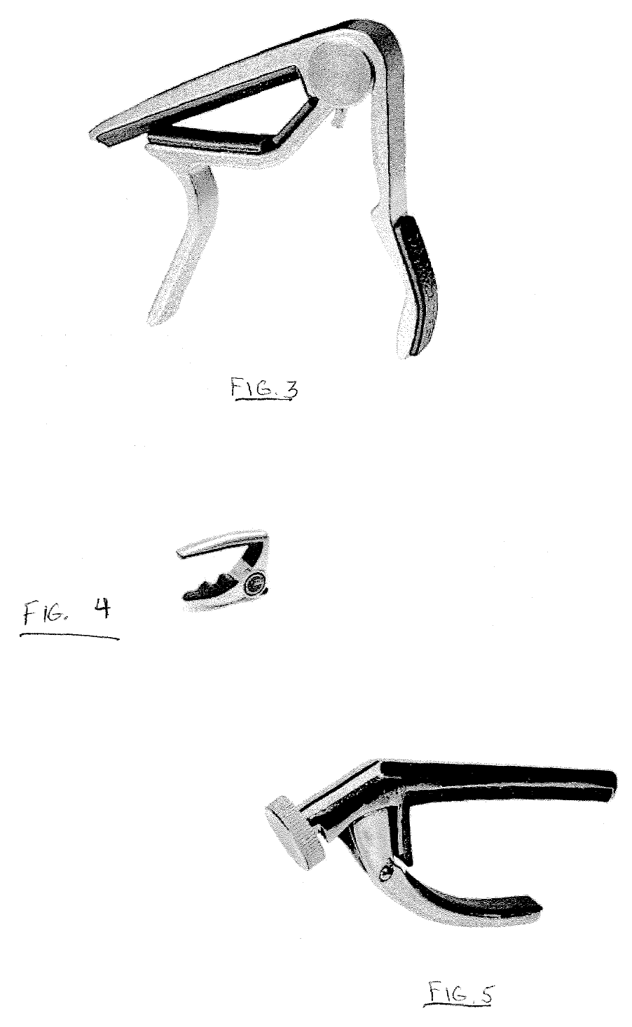

FIG. 9 illustrates another exemplary device 100-4 in which the capo portion is modeled after a Dunlop® brand guitar capo as shown in FIG. 3. The exemplary device 100-4 includes a finger board-engaging portion 110-4, a neck-engaging portion 120-4 and a tensioning member 450 in the form of a self-biasing spring (not shown). An opener 150-5, similar in form to opener 150-1 shown in FIG. 6 extends from the free end 480 of an extension arm 485 of neck-engaging portion 120-4. The opener 150-5 has a bottle cap lip-engaging portion 162-5 and a cap leveraging portion 165-5 in the form of a surface region 166-5. Upon engagement with the bottle cap, rotation of the opener in the direction of arrow 486 will disengage the cap from the bottle

In an alternative aspect illustrated in FIG. 9 by dotted lines, an opener 150-6, similar to opener 150-2 shown in FIG. 6, extends from an end 490 of an oppositely extending portion 495 of finger board-engaging portion 110-4. The capo of device 100-4 is engaged/disengaged with the instrument by squeezing portions 495 and 485 in the directions of arrows 440.

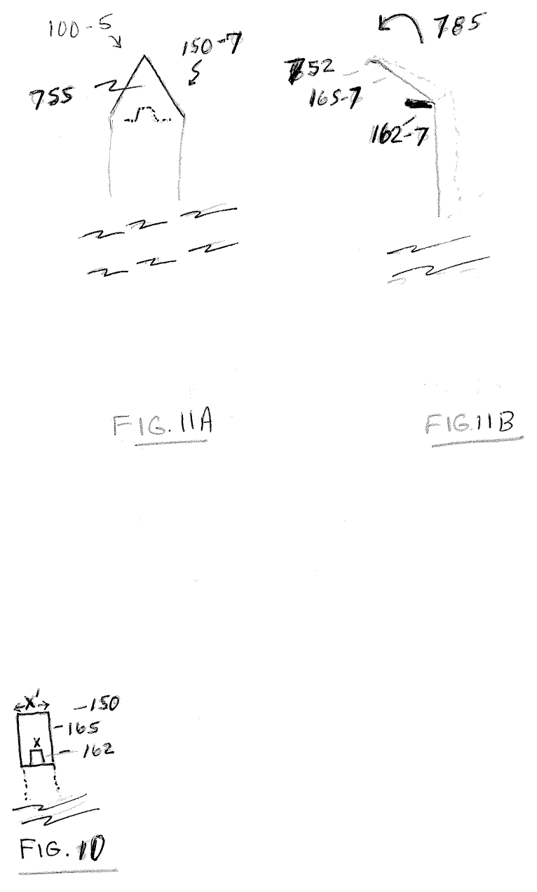

It is to be appreciated that the shape and dimensions of any of the container opener aspects described above need only be precise enough to properly engage a standard crown cap. In general, as illustrated in FIG. 10, a transverse dimension X of the cap lip-engaging member 162 will be less than a corresponding transverse dimension X′ of the cap surface leverage member 165. In a particular aspect, the cap lip-engaging member has a transverse dimension X on the order of 2 mm or less.

In a further alternative aspect as shown in FIGS. 11A and 11B, the container opener portion 150-7 of a device 100-5 according to an embodiment of the invention is designed to puncture the metalized surface of a container. The opener 150-7 has a container lip-engaging member 162-7 and a container puncturing member 165-7. The puncturing member 165-7 has a generally pointed end 752 and a generally tapered or triangular surface shape as shown at 755. The lip-engaging member 162-7 allows the opener 150-7 to pivot on the container edge and puncture the container surface when the opener is rotated in the direction of arrow 785.

Although the exemplary devices illustrated in FIGS. 6-9 are in part modeled on popular, commercially available capos, it is to be appreciated that the capo style is not a part of the invention per se. Any capo device having a finger board-engaging portion, a neck-engaging portion and a tensioning member, as those terms are used herein, will be suitable to include a crown cap type container opener, a church key type opener or a puncture type can opener from a free end of any of the finger board-engaging portion, neck-engaging portion or tensioning member so long as the opener does not foul the operational aspect of the capo.

The foregoing description of the embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

I claim:

1. A device, comprising:
a capo; and
a container opener integrally coupled to the capo.

2. The device of claim 1, wherein the capo comprises a fingerboard-engaging portion; a neck-engaging portion movably connected to the fingerboard-engaging portion; and a tensioning member connected to at least one of the fingerboard-engaging portion and the neck-engaging portion.

3. The device of claim 2, wherein the tensioning member comprises a self-biasing element.

4. The device of claim 2, wherein the tensioning member comprises a ratchet component.

5. The device of claim 2, wherein the tensioning member comprises a lever arm and an adjustable stop.

6. The device of claim 2, wherein at least one of the fingerboard-engaging portion and the neck-engaging portion and the tensioning member includes the container opener.

7. The device of claim 6, wherein the container opener is coupled to a free-end of the at least one of the fingerboard-engaging portion and the neck-engaging portion and the tensioning member.

8. The device of claim 1, wherein the container opener is a bottle cap remover.

9. The device of claim 8, wherein the bottle cap remover includes a bottle cap lip-engaging member and an integral leverage member.

10. The device of claim 9, wherein the leverage member is a surface region of the bottle cap remover.

11. The device of claim 9, wherein the lip-engaging member and the leverage member have a separation distance sufficient to operably, simultaneously engage a lip of the bottle cap and an exterior surface of the bottle cap, respectively.

12. The device of claim 9, wherein the lip-engaging member has a transverse dimension that is less than a transverse dimension of the leverage member.

13. The device of claim 12, wherein the transverse dimension of the lip-engaging member is less than about 2 millimeters.

14. The device of claim 1, wherein the container opener is a container surface-puncturing element.

15. The device of claim 14, wherein the container opener includes a container lip-engaging member and an integral puncturing member.

16. The device of claim 15, wherein the puncturing member has a tapered end.
